(19) United States
(12) Patent Application Publication
(10) Pub. No.: US 2005/0075835 A1
(43) Pub. Date: Apr. 7, 2005

(54) System and method of real-time statistical bin control

(76) Inventors: Ta-Feng Tseng, Shanhua Township (TW); Lee-Chung Lin, Chia-Tung Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/935,377

(22) Filed: Sep. 7, 2004

(30) Foreign Application Priority Data
Sep. 9, 2003 (TW) 92124847

(51) Int. Cl. G06F 15/00

(52) U.S. Cl. 702/179

(57) ABSTRACT

A method and system of real-time statistical bin control. First, a statistical bin control rule is generated by a statistical bin control rule generator, and a test result having an error frequency is then retrieved from test equipment. If the error frequency exceeds a preset limit, the system replies to the test equipment with a first action corresponding to the statistical bin control rule. Next, if the error frequency of the test results exceeds another limit, the system then replies to the test equipment with a second action corresponding to the statistical bin control rule.

### BACKGROUND OF THE INVENTION

1. Field of the Invention

The present invention relates to a system and method of statistical bin control, and in particular to a system and method of real-time statistical bin control of test equipment and error state recovery thereof in accordance with statistical bin control data.

2. Description of the Related Art

In integrated circuit manufacturing, testing is the final step, detecting defects generated during the process and ascertaining causes thereof. Testing enhances yield rate and development of data for manufacturing analysis. Integrated circuit testing can comprise circuit probe (or wafer sort), and final test (or package test). Circuit probe (CP) testing is executed among wafer formations to detect the quality of the dies before the package process for avoiding the wasting of both time and costs. When memory product testing is performed, recoverable dies verified by circuit probe are recovered by laser repair to raise the yield rate. Final testing is performed after the package process to ensure that chips conform to the standards. However, in most situations, abnormal test results can be caused by contamination of probe-needles or other abnormal conditions of the test equipment rather than actual wafer defects, generating a clean needle command by a monitoring system to clean the probe-needles after testing. Although the monitoring system acts on errors in the presence of contamination of the probe-needles or any abnormal condition, in fact, any individual occurrence of contamination or other abnormal condition rarely adversely influences the test results, despite slowing the performance of the test equipment causing reduced capacities. As a result, a statistical control method is required to determine when to clean the probe-needles or act on errors if the number of detected abnormal situations reaches a critical number.

Statistical process control (SPC) thus improves the process, maintains the control states, and prevents the production of defective products. Statistical process control can consider manufacturing process events from the past, govern present conditions, and predict effects in the future.

FIG. 1 is a schematic diagram showing a conventional offline statistical bin control (SBC) operation, in which statistical control actions are performed offline manually after CP testing. After each wafer lot 11 is CP tested on test equipment 13, raw data (SBC charts) 15 is retrieved from the test equipment 13 to execute statistical data control. If a wafer lot 11 has finished testing and its raw data shows that it exceeds the control limit of SBC 17, wafer lot 11 must be re-tested, after abnormal conditions are eliminated from the test equipment 13. This is time-consuming and results in extra production cost.

In addition, in the conventional method, there is no automation link between the control system and test equipment, such that statistical bin control data must be handled manually with offline statistical control at a predetermined time (for example, a day) in accordance with conditions predetermined by the test results of wafers and system shutdown. The test equipment is forced to stop the testing procedure by the way of suspending the test program when the test results reach the predetermined conditions for system shutdown. However, tested wafers must be re-tested in this period to determine whether their test results are correct. Thus, test equipment wastes considerable time re-testing, and the performance is affected. Therefore, it is an important object to detect abnormal states early and return the test equipment to the normal state of operation.

### SUMMARY OF THE INVENTION

It is therefore an object of the present invention to provide a method and system of real-time statistical bin control to improve processing time and avoid extra costs.

To achieve this and other objects, present invention provides a method and system of real-time statistical bin control for collecting error messages from test equipment for statistical classification, and enabling test equipment error state recovery according to the statistical data classification.

According to one embodiment of the invention, a method of real-time statistical bin control performs the following steps. First, a statistical bin control rule generator obtains CD testing history data from a statistical bin control database and generates statistical bin control rules accordingly.

A test result is retrieved from test equipment and according thereto, the system checks whether a number of consistent returns of one result type exceeds a first limit. The system replies to the test equipment with an action corresponding to the one result type and the statistical bin control rule if the number of consistent returns one result type exceeds the first limit.

Next, if a number of accumulative returns of one result type exceed a second limit, the system also replies to the test equipment with an action corresponding to the one result type and the statistical bin control rule if the number of accumulative returns of one result type exceeds the second limit.

According to another embodiment of the invention, a system of real-time statistical bin control comprises a statistical bin control rule generator and a statistical bin control unit.

The statistical bin control rule generator generates a statistical bin control rule in accordance with CP testing history data,

The statistical bin control unit retrieves a test result from the test equipment and according thereto, the system checks whether a number of consistent returns of one result type exceed a first limit. The system replies to the test equipment with an action corresponding to the one result type and the statistical bin control rule if the number of consistent returns one result type exceeds the first limit. The system then checks whether a number of accumulative returns of one result exceed a second limit and if so, replies with a second action corresponding to the one result type and the statistical bin control rule if the number of accumulative returns of one result type exceeds the second limit.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of an offline SBC operation flow of the prior art;

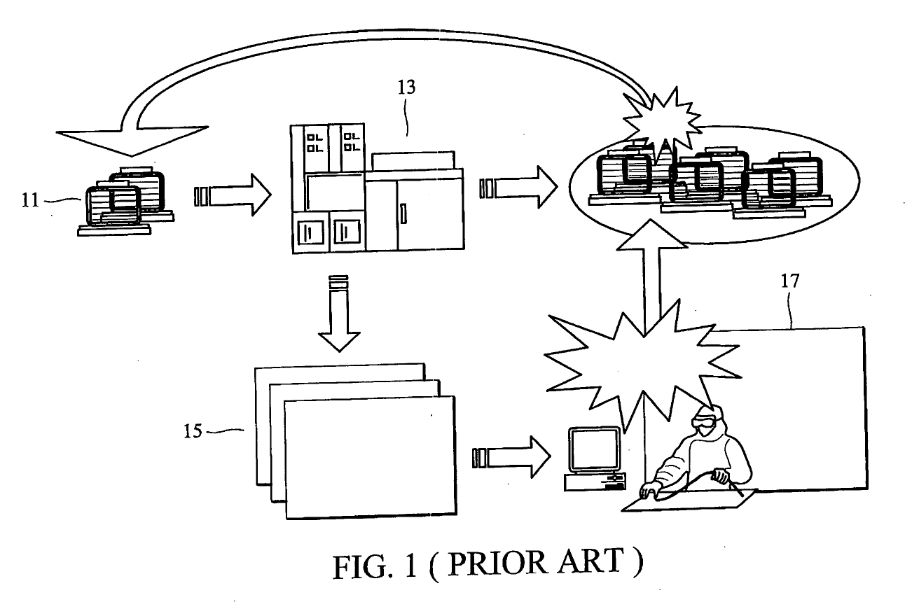

FIG. 2 is a schematic diagram of a real-time SBC operation according to an embodiment of the present invention;

FIG. 3 is a schematic diagram of architecture of the real-time SBC system of FIG. 2;

FIG. 4 is a schematic diagram of test results generated using the real-time SBC system of FIG. 3;

FIG. 5 is a flowchart of a method of real-time SBC according to another embodiment of the present invention;

FIG. 6 is a flowchart of a method utilizing the SBC mechanism to handle results from the circuit probe test.

### DETAILED DESCRIPTION OF THE INVENTION

The present invention discloses a system of real-time statistical bin control (SBC) for detecting abnormal test results from circuit probe testing and performing a real-time recovery action according to the test result.

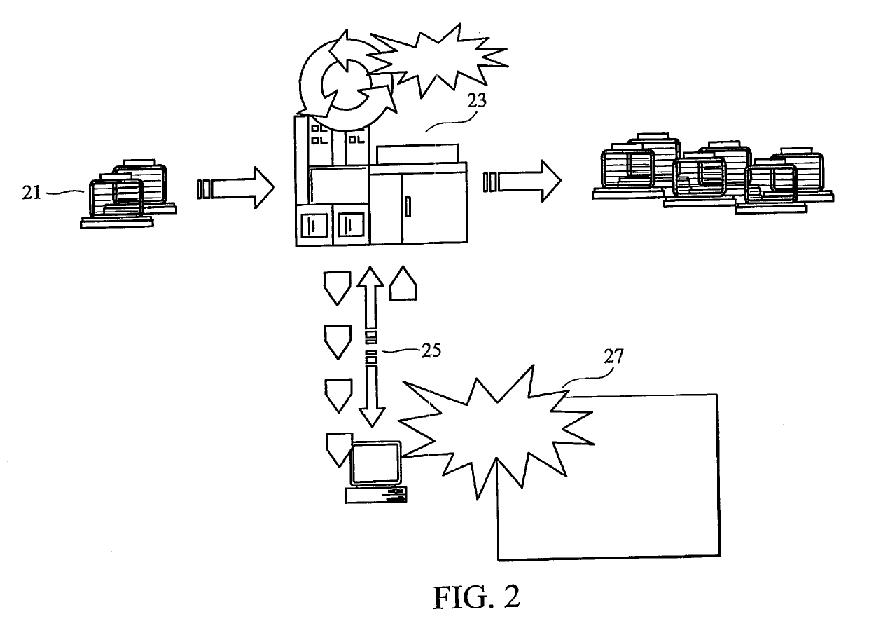

FIG. 2 is a schematic diagram showing a real-time SBC operation of the present invention. A wafer lot 21 [“11” on FIG. 2 should be replaced with “21”] is tested by circuit probe on test equipment 23, and real-time SBC is executed through a communication channel 25 complying with semiconductor equipment communication standard (SECS) protocol in accordance with circuit probe test bin results from test equipment 23. The system issues a recovery command through the communication channel 25 to the test equipment 23 when the SBC system detects abnormal states exceeding SBC control limits 27, thereby executing a real-time recovery action corresponding to the command.

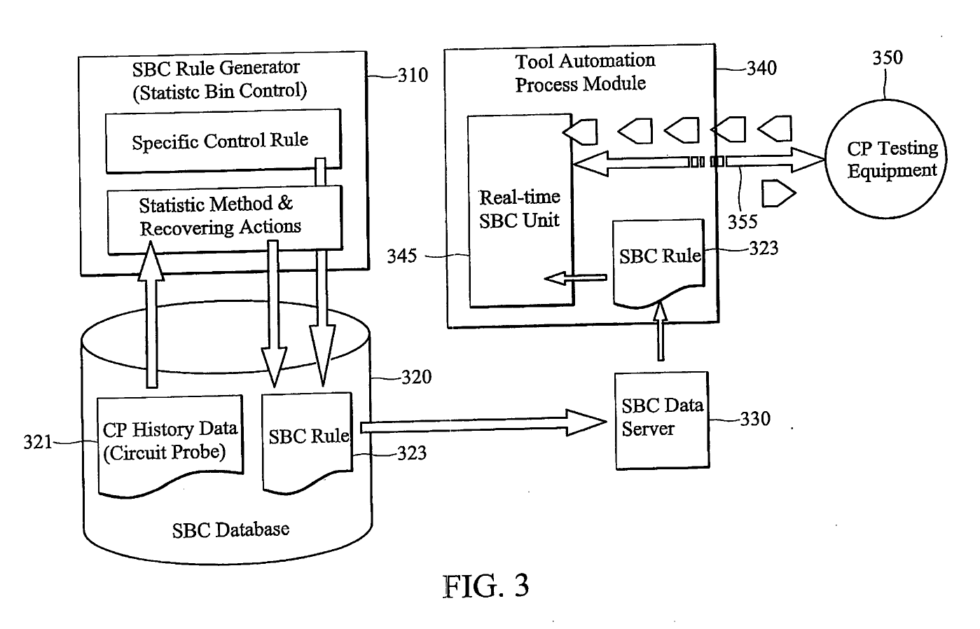

FIG. 3 is a schematic diagram showing one embodiment of architecture of a real-time SBC system of the present invention. The architecture comprises a SBC rule generator 310, a SBC database 320, a SBC data server 330, a tool automation process module 340, and circuit probe test equipment 350. The system produces test results according to the testing states, stored in the SBC database 320 for analysis to determine the appropriate statistic method and recovery action.

The SBC rule generator 310 determines proper the SBC rule 323 in accordance with CP testing history data 321 stored in the SBC database 320. Some special products require specific control rules, and the SBC rule generator 310 determines the SBC rule 323 in accordance with the CP testing history data 321 and the specific control rules. Furthermore, statistical rules for different models of test equipment are stored in the SBC database 320.

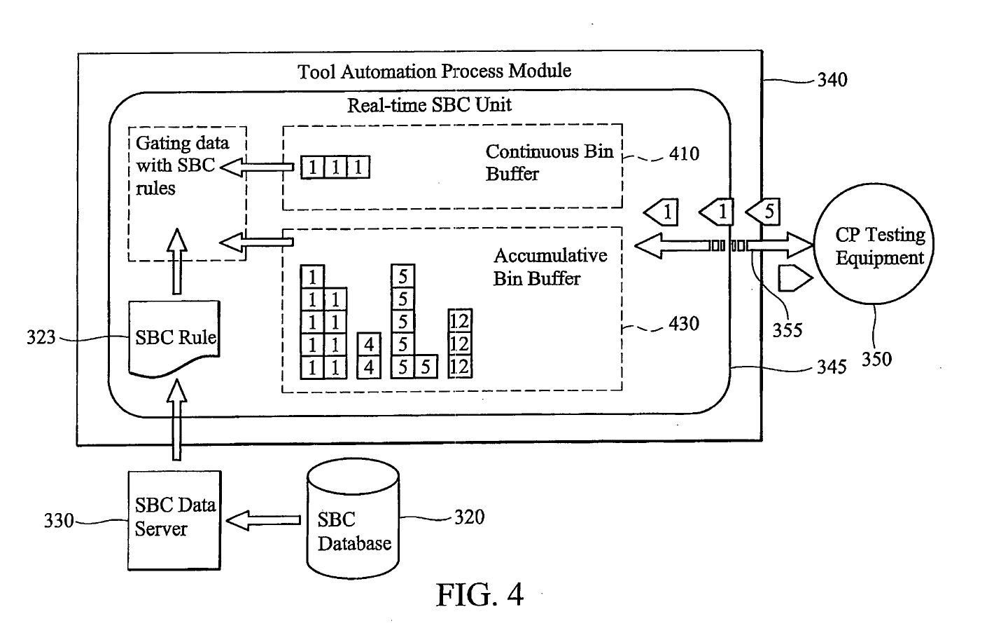

FIG. 4 is a schematic diagram showing test results generated by a mechanism utilized by the real-time SBC system of the present invention. A real-time SBC unit 345 is internally set in the tool automation process module 340 for detecting test states from the circuit probe test equipment 350 and responding with an action corresponding to the SBC rule 323. The tool automation process module 340 further comprises a continuous bin buffer 410 and an accumulative bin buffer 430.

The circuit probe test equipment 350 generates relevant test results, which may have error messages, divided into several types. The test results from the circuit probe test equipment 350 are sorted and then encoded with, for example, ID values such as 1 (one) if test results are passed, and 2 (two) if test results are error type 1, and so on.

Test results are stored in the accumulative bin buffer 430 after every test. The tool automation process module 340 issues a recovery command in real time through communication channel 355 complying with SECS protocol in accordance with the SBC rule 323 to recover from error states of the circuit probe test equipment 350. Furthermore, the ID number of test results is stored in the continuous bin buffer 410, if the running test results of the testing procedure are the same. Real-time SEC unit 345 obtains the SEC rule 323 through the SEC data server 330, and the error states of the circuit probe test equipment 350 is monitored according to the SBC rule 323. The tool automation process module 340 issues a recovery command through the communication channel 355 in accordance with the SEC rule 323 to recover from error states of the circuit probe test equipment 350.

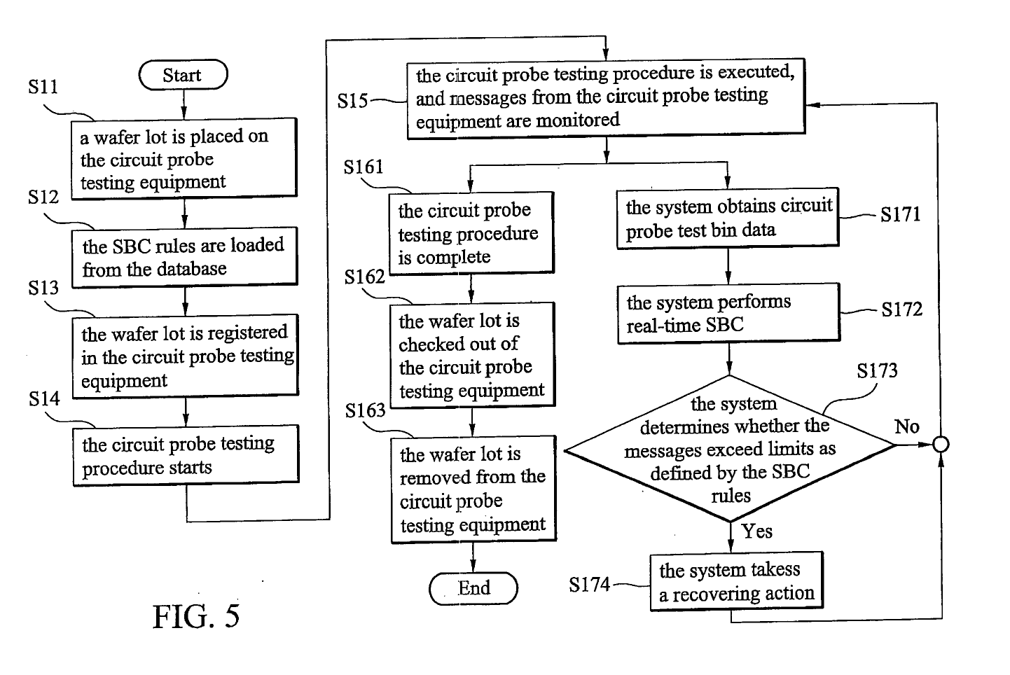

FIG. 5 is a flowchart of a method of real-time SBC according another embodiment of the present invention.

In step S11, a wafer lot is placed on the circuit probe test equipment.

In step S12, the SEC rules are loaded from the database. The SEC rules are loaded from the SBC database by the SEC rules generator.

In step 313, the wafer lot is registered in the circuit probe test equipment.

In step S14, the circuit probe testing procedure starts.

In step S15, the circuit probe testing procedure is executed, and messages from the circuit probe test equipment are monitored. The system executes the circuit probe testing procedure, collects messages from the circuit probe test equipment, and performs actions accordingly.

In step S161, the circuit probe testing procedure is complete. The circuit probe test equipment generates relevant messages when the circuit probe testing procedure has finished.

In step S162, the wafer lot is checked out of the circuit probe test equipment.

In step S163, the wafer lot is removed from the circuit probe test equipment, and the circuit probe testing procedure is terminated.

In step S171, the system obtains circuit probe test bin data from the circuit probe test equipment through a communication channel complying with SECS protocol.

In step S172, the system performs real-time SBC. The system monitors the messages from the circuit probe test equipment in accordance with the SBC rules.

In step S173, the system determines whether the messages exceed limits as defined by the SBC rules.

In step S174, the system issues a command through the communication channel to the circuit probe test equipment to take recovery action if the messages exceed limits as defined by the SBC rules.

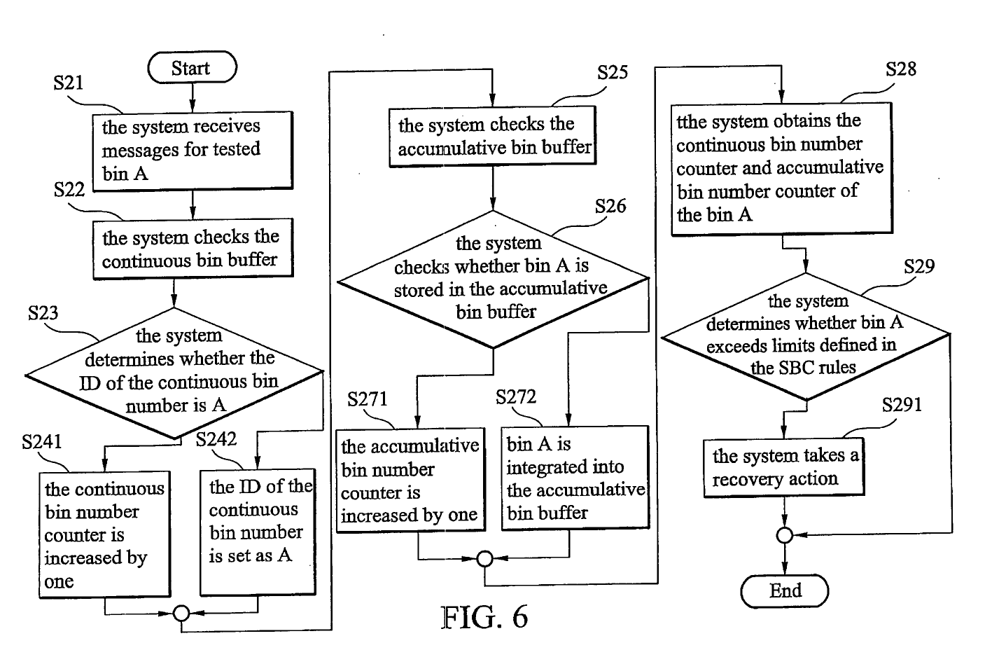

FIG. 6 is a flowchart of a method for utilizing the SBC mechanism to handle test results from the circuit probe test equipment.

In step S21, the system receives messages for tested bin A, A representing an unspecified identification (ID) number, from the circuit probe test equipment through the communication channel complying with SECS protocol.

In step S22, the system checks the continuous bin buffer. The messages from circuit probe test equipment may contain error data. The messages are sorted and then encoded, for example, the ID of the test result is 1 (one) if test results are passed, and 2 (two) if test results are error type 1, and so on. The ID of the error message is stored in the continuous bin buffer, if it appears repeatedly.

In step S23, the system determines whether the ID of the continuous bin number is A. An ID of the continuous bin number variable is set in the system. The ID of the continuous bin number variable is set as an ID of the error message when the system receives the ID of the error message.

In step S241, the continuous bin number counter is increased by one. A continuous bin number counter increases the count by one when the ID of a continuous bin number in the continuous bin buffer appears repeatedly. The ID of the continuous bin number received in step S11 is A, and the continuous bin number counter adds one if the last ID of bin data is A.

In step S242, the ID of the continuous bin number is set as A. The ID of the continuous bin number is set as A if the received ID of the continuous bin number is not A, and the continuous bin number counter is set as one for re-counting.

In step S25, the system checks the accumulative bin buffer in which ID of test results from every testing procedure are stored.

In step S26, the system checks whether bin A is stored in the accumulative bin buffer.

In step S271, the accumulative bin number counter is increased by one. An accumulative bin number counter is set to calculate the ID of the bin number. When the accumulative bin buffer has stored the bin A, the accumulative bin number counter is increased by one if the system receives the bin A again.

In step S272, bin A is integrated into the accumulative bin buffer, and the accumulative bin number counter is increased by one if it has had bin A.

In step S28, the system obtains the continuous bin number counter and accumulative bin number counter of the bin A in accordance with the SBC rules.

In step S29, the system determines whether bin A exceeds limits defined in the SBC rules.

In step S291, the system issues a command to take a recovery action to recover the test equipment when the values of the continuous bin number counter and accumulative bin number counter of the bin A exceed a limit separately.

The method of real-time SBC according to the invention establishes an automated link between control and test equipment to set various SBC conditions and abnormal states removing commands thereof. The system issues commands without manual operation using the automated link to the test equipment to respond to abnormal conditions or errors, without suspending the testing procedure.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method of real-time statistical bin control for classification of results from test equipment and responding correspondingly, comprising the steps of:
retrieving test results from the test equipment;
checking if a number of consistent returns of one result type exceeds a first limit;
responding with a first action corresponding to the one result type and a statistical bin control rule if the number of consistent returns exceeds the first limit;
checking if a number of accumulative returns of one result type exceeds a second limit; and
responding with a second action corresponding to the one result type and the statistical bin control rule if the number of accumulative returns exceeds the second limit.

2. The method as claimed in claim 1, wherein in the retrieving step, the test results are retrieved through a communication channel complying with Semiconductor Equipment Communication Standard (SECS) protocol.

3. The method as claimed in claim 1, wherein in the step of checking the number of consistent returns, the number of consistent returns is stored in a continuous bin buffer.

4. The method as claimed in claim 1, wherein in the step of checking the number of accumulative returns, the number of accumulative returns is stored in an accumulative bin buffer.

5. The method as claimed in claim 1, wherein in the step of responding with the first action corresponding to the one result type, the statistical bin control rule is generated from a statistical bin control rule generator.

6. The method as claimed in claim 5, wherein in the step of responding with the first action corresponding to the one result type, the statistical bin control rule generator determines the statistical bin control rule in accordance with at least one of circuit probe (CP) testing history data and a specific control rule.

7. The method as claimed in claim 1, wherein in the step of responding with the first action corresponding to the one result type, the first action is relayed to the test equipment through a communication channel complying with SECS protocol.

8. A system of real-time statistical bin control for classification of test results from test equipment and responding with a corresponding action, comprising:
a statistical bin control unit for retrieving the test results having a number of consistent returns from the test equipment, checking if the number of consistent returns of one result type exceeds a first limit, responding with a first action corresponding to the one result type and a statistical bin control rule if the number of consistent returns exceeds the first limit, checking if a number of accumulative returns of one result type exceeds a second limit, and responding with a second action corresponding to the one result type and the statistical bin control rule if the number of accumulative returns exceeds the second limit.

9. The system as claimed in claim 9, wherein the test results are retrieved through a communication channel complying with SECS protocol.

10. The system as claimed in claim 8, wherein the number of consistent returns of the one result type is stored in a continuous bin buffer.

11. The system as claimed in claim 8, wherein the number of accumulative returns of the one result type is stored in an accumulative bin buffer.

12. The system as claimed in claim 8, wherein the statistical bin control rule is generated from a statistical bin control rule generator.

13. The system as claimed in claim 12, wherein the statistical bin control rule generator determines the statistical bin control rule in accordance with at least one of CF testing history data and a specific control rule.

14. The system as claimed in claim 8, wherein the first action is relayed to the test equipment through a communication channel complying with SECS protocol.

15. A method of real-time statistical bin control for receiving a test result from test equipment and responding to the test equipment with a corresponding action in accordance with the test result, comprising the steps of:
obtaining of CP testing history data from a statistical bin control database by a statistical bin control rule generator;
generating a statistical bin control rule according to the CP testing history data;
retrieving the test results from the test equipment;
checking if a number of consistent returns of one result type exceeds a first limit;
responding with a first action corresponding to the one result type and a statistical bin control rule if the number of consistent returns exceeds the first limit;
checking if a number of accumulative returns of one result type exceeds a second limit; and
responding with a second action corresponding to the one result type and the statistical bin control rule if the number of accumulative returns exceeds the second limit.

16. The method as claimed in claim 15, wherein in the generating step, the statistical bin control rule generator further determines the statistical bin control rule in accordance with a specific control rule.

17. The method as claimed in claim 15, wherein in the retrieving step, the test results are retrieved through a communication channel complying with SECS protocol.

18. The method as claimed in claim 15, wherein in the step of checking the number of consistent returns, the number of consistent returns is stored in a continuous bin buffer.

19. The method as claimed in claim 15, wherein in the step of checking the number of accumulative returns, the number of accumulative returns is stored in an accumulative bin buffer.

20. The method as claimed in claim 15, wherein in the step of responding with the first action corresponding to the one result type, the first action is relayed to the test equipment through a communication channel complying with SECS protocol.

21. A system of real-time statistical bin control for receiving a test result from test equipment and responding to the test equipment with a corresponding action in accordance with the test result, comprising:
a statistical bin control rule generator for generating a statistical bin control rule in accordance with CP testing history data; and
a statistical bin control unit for retrieving the test results having a number of consistent returns from the test equipment, checking if the number of consistent returns of one result type exceeds a first limit, responding with a first action corresponding to the one result type and the statistical bin control rule if the number of consistent returns exceeds the first limit, checking if a number of accumulative returns of one result type exceeds a second limit, and responding with a second action corresponding to the one result type and the statistical bin control rule if the number of accumulative returns exceeds the second limit.

22. The system as claimed in claim 21, wherein the test results are retrieved through a communication channel complying with SECS protocol.

23. The system as claimed in claim 21, wherein the number of consistent returns is stored in a continuous bin buffer.

24. The system as claimed in claim 21, wherein the number of accumulative returns is stored in an accumulative bin buffer.

25. The system as claimed in claim 21, wherein the statistical bin control rule generator determines the statistical bin control rule in accordance with a specific control rule.

26. The system as claimed in claim 21, wherein the first action is relayed to the test equipment through a communication channel complying with SECS protocol.

27. A storage medium, comprising a program with a plurality of codes for implementing steps of:
retrieving test results from the test equipment;
checking if a number of consistent returns of one result type exceeds a first limit;
responding with a first action corresponding to the one result type and a statistical bin control rule if the number of consistent returns exceeds the first limit;
checking if a number of accumulative returns of one result type exceeds a second limit; and
responding with a second action corresponding to the one result type and the statistical bin control rule if the number of accumulative returns exceeds the second limit.

28. A storage medium, comprising a program with a plurality of codes for implementing steps of:
obtaining of CP testing history data from a statistical bin control database by a statistical bin control rule generator;
generating a statistical bin control rule according to the CP testing history data;
retrieving the test results from the test equipment;
checking if a number of consistent returns of one result type exceeds a first limit;
responding with a first action corresponding to the one result type and a statistical bin control rule if the number of consistent returns exceeds the first limit;
checking if a number of accumulative returns of one result type exceeds a second limit; and
responding with a second action corresponding to the one result type and the statistical bin control rule if the number of accumulative returns exceeds the second limit.
